(19) United States
(12) Patent Application Publication
(10) Pub. No.: US 2011/0128222 A1
(43) Pub. Date: Jun. 2, 2011

(54) INFORMATION PROCESSING APPARATUS AND CONTROL METHOD

(75) Inventors: Toshiyuki HIROTA, Hino-shi (JP); Koichi KAJI, Hidaka-shi (JP); Masao TESHIMA, Kunitachi-shi (JP)

(73) Assignee: KABUSHIKI KAISHA TOSHIBA, Tokyo (JP)

(21) Appl. No.: 12/904,962

(22) Filed: Oct. 14, 2010

(30) Foreign Application Priority Data
Nov. 30, 2009 (JP) 2009-272694

(51) Int. Cl. G06F 3/033

(52) U.S. Cl. 345/158

(57) ABSTRACT

According to one embodiment, a switch circuit switches a resonance frequency band of an antenna in a display unit between first and second resonance frequency bands. The second resonance frequency band is overlapped with a part of the first resonance frequency band and is higher than the first resonance frequency band. A wireless communication module wirelessly transmits and receives signals using a transmission frequency band and a reception frequency band which are included in the first resonance frequency band. A screen image orientation control module changes an orientation of a screen image displayed on the display unit. A resonance frequency shift module shifts the resonance frequency band of the antenna from the first resonance frequency band to the second frequency band by controlling the switch circuit when the orientation of the screen image is an orientation in which the antenna is positioned on a downward side of the screen image.

### CROSS-REFERENCE TO RELATED APPLICATIONS

This application is based upon and claims the benefit of priority from Japanese Patent Application No. 2009-272694, filed Nov. 30, 2009; the entire contents of which are incorporated herein by reference.

### FIELD

Embodiments described herein relate generally to an information processing apparatus including a display unit having a built-in antenna, and to a control method applied to the same apparatus.

### BACKGROUND

In recent years, various portable personal computers such as a notebook personal computer have been developed. For example, most portable personal computers have a wireless communication function in order to perform a wireless communication with an external device such as an Internet server under the mobile environment. In a portable personal computer, usually, an antenna is built into a display unit.

Moreover, recently, the number of mobile wireless communication usable channels is increasing, and in addition, the types of wireless communications are increasing. A portable personal computer having a plurality of built-in antennas has been developed.

An information processing apparatus including an antenna, for example, a computer including an antenna requires to reduce a specific absorption rate (SAR). The foregoing SAR is a physical quantity showing a degree of electromagnetic wave energy absorbed by a human body.

Jpn. Pat. Appln. KOKAI Publication No. 2007-235329 discloses a computer having a function of reducing a SAR. The computer includes a display unit having a built-in antenna. The computer is capable of changing the orientation of an image displayed on a display module in the display unit. Further, in the computer, it is determined whether or not an antenna is positioned on the downward side of an image displayed on a display module. If the image is positioned on the downward side, the control for preventing electromagnetic radiation from the antenna is carried out.

However, in order to prevent electromagnetic radiation from the antenna, a wireless communication module must be additionally provided with a specific function of restricting a transmission power as the need arises. In order to realize a wireless communication module additionally provided with the foregoing specific function, much time and cost are required.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing the appearance of an information processing apparatus according to one embodiment;

FIG. 2 is an exemplary view to explain two display modes usable when the information processing apparatus of this embodiment is in a tablet mode;

FIG. 3 is an exemplary view to explain another two display modes usable when the information processing apparatus of this embodiment is in a tablet mode;

FIG. 4 is an exemplary view showing an available mode when an antenna is positioned on the downward side of a screen image of the information processing apparatus of this embodiment;

FIG. 5 is an exemplary view to explain an operation of shifting a resonance frequency of an antenna, executed by the information processing apparatus of this embodiment;

FIG. 6 is an exemplary view to explain another operation of shifting an antenna resonance frequency, executed by the information processing apparatus of this embodiment;

FIG. 7 is an exemplary block diagram showing the system configuration of the information processing apparatus of this embodiment;

FIG. 8 is an exemplary diagram showing the configuration of an antenna built into the information processing apparatus of this embodiment;

FIG. 9 is an exemplary view to explain a screen image orientation control operation executed by the information processing apparatus of this embodiment;

FIG. 10 is an exemplary flowchart to explain a first procedure example of an antenna resonance frequency shift processing executed by the information processing apparatus of this embodiment;

FIG. 11 is an exemplary flowchart to explain a second procedure example of an antenna resonance frequency shift processing executed by the information processing apparatus of this embodiment; and

FIG. 12 is an exemplary flowchart to explain a third procedure example of an antenna resonance frequency shift processing executed by the information processing apparatus of this embodiment.

### DETAILED DESCRIPTION

Various embodiments will be described hereinafter with reference to the accompanying drawings.

In general, according to one embodiment, an information processing apparatus comprises a display unit including an antenna. The apparatus comprises a switch circuit, a wireless communication module, a screen image orientation control module and a resonance frequency shift module. The switch circuit is configured to switch a resonance frequency band of the antenna between first and second resonance frequency bands. The first resonance frequency band covers a first transmission frequency band and a first reception frequency band higher than the first transmission frequency band. The foregoing second resonance frequency band is overlapped with a part of the first resonance frequency band and higher than the first resonance frequency band. The wireless communication module is configured to wirelessly transmit and receive signals using the first transmission frequency band and the first reception frequency band. The screen image orientation control module is configured to change the orientation of a screen image displayed on a display screen of the display unit. The resonance frequency shift module is configured to shift the resonance frequency band of the antenna from the first resonance frequency band to the second frequency band by controlling the switch circuit when the orientation of the screen image is an orientation in which the antenna is positioned on a downward side of the screen image.

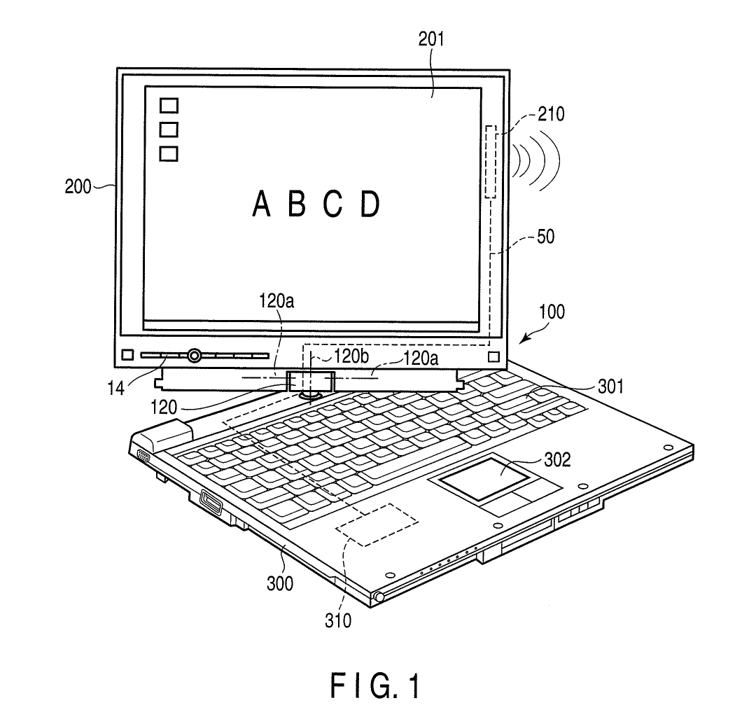

FIG. 1 is a perspective view showing the appearance of an information processing apparatus according to one embodiment. The information processing apparatus is realized as a portable personal computer 100. The computer 100 is configured to function as a so-called “compatible tablet personal computer (PC)”. This computer 100 is usable in a state capable of taking two styles, that is, a “PC style” and a “tablet style”. The “PC style” is an available mode in which a display screen of a display unit and a keyboard on the upper surface of a main body are both exposed. The “tablet style” is an available mode in which the display screen is exposed and the backside of the display unit covers the upper surface of the main body.

The computer 100 comprises a display unit 200 and a computer main body (simply referred to as main body) 300. The display unit 200 is incorporated with a liquid crystal display (LCD) 201. The LCD 201 may be a touch screen device. A display screen of the LCD 201 is positioned approximately at the center of the display unit 200.

The display unit 200 is rotatably attached to the computer main body 300 by way of a hinge member 120. The hinge member 120 has two axes, that is, a first axis 120a extending parallel with the upper surface of the computer main body 300 and a second axis 120b extending vertically to the first axis 120a. The display unit 200 is attached to the computer main body 300 so that it is rotatable around the first axis 120a. In other words, the display unit 200 is rotatable around the first axis 120a between an open position and a closed position. According to the open position, the upper surface of the computer main body 300 is exposed. Conversely, according to the closed position, the upper surface of the computer main body 300 is covered with the display unit 200. Further, the display unit 200 is rotatable around the second axis 120b by an angle of 180°. In other words, the display unit 200 is rotatable between the following first and second positions. Namely, one is a first position (rotation angle of display unit is 0°) in which the display screen of the LCD 201 is oriented to the front side of the computer 100. The other is a second position (rotation angle of display unit is 180°) in which the backside of the display unit 200 is oriented to the front side of the computer 100.

The foregoing “tablet style” is equivalent to the state described below. Specifically, the display unit 200 is rotated around the second axis 120b by an angle of 180° and the display unit 200 is closed. Namely, the backside of the display unit 200 is set to a position such that the upper surface of the computer main body 300 is covered.

The surface of the display unit 200, for example, the lower left portion thereof is provided with a control panel including various input buttons. Therefore, in the “tablet style”, users can input various events by operating various buttons of the control panel 14.

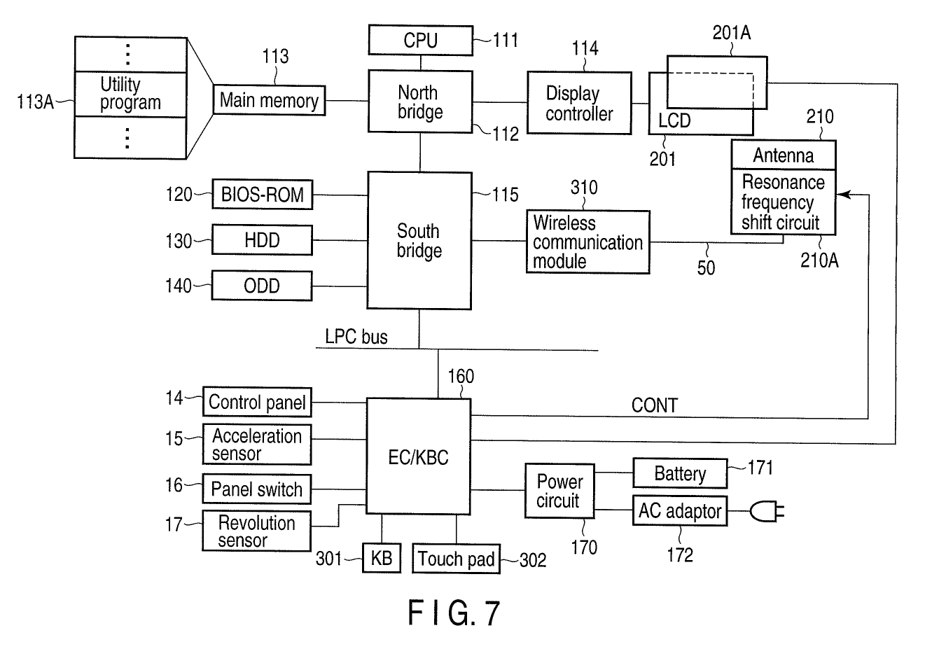

The inside of the display unit 200 is provided with an antenna 210. The antenna 210 is built into a certain end portion of the rectangular display unit 200. FIG. 1 shows an example in which the right end of the display unit 200 is provided with an antenna 210. The antenna 210 is additionally provided with a switch circuit described later, after FIG. 7. The foregoing antenna 210 and switch circuit function as a reconfigurable antenna, which is capable of changing a resonance frequency band. Specifically, the switch circuit switches a resonance frequency band of the antenna 210 between first and second resonance frequency bands. The antenna 210 is connected to a feeder line 50, which extends from the main body 300 to the display unit 200 by way of the hinge member 120.

The computer main body 300 is a base unit having a thin box body. The upper surface of the computer main body 300 is provided with a keyboard 301 and a touch pad 302. The inside of the computer main body 300 is provided with a system board (called a mother board) on which various electronic components are mounted. The system board is provided with a wireless communication module 310.

The wireless communication module 310 wirelessly transmits and receives signals according to frequency division multiplexing using a transmission frequency band and a reception frequency higher than the transmission frequency band. For example, the wireless communication module 310 is realized as a wireless communication module which executes a communication with an external device according to third generation mobile telecommunications (3G). The module 310 is connected to a bus slot formed on the system board. According to the foregoing third generation mobile telecommunications (3G), a 850 MHz band (824 MHz to 894 MHz) or 900 MHz band (880 MHz to 960 MHz) is used. For example, the 850 MHz band is used for Japan and the United States; on the other hand, the 900 MHz band is used for Europe. For example, the module 310 connected to a bus slot on the system board is realized as a world wide wireless communication module, which is adaptable to a plurality of frequency bands corresponding to various destinations. In each of the foregoing frequency bands, a pair of a transmission frequency band and a reception frequency band is defined. Specifically, the wireless communication module 310 wirelessly transmits and receives signals using a pair of a transmission frequency band and a reception frequency band, defined in the 850 MHz band. Further, the module 310 wirelessly transmits and receives signals using a pair of a transmission frequency band and a reception frequency band, defined in the 900 MHz band. The use of either of the foregoing 850 MHz band or 900 MHz band is determined depending on the destination of the computer 100.

For example, a resonance frequency band of the antenna 210 to which a switch circuit is added is switched between a resonance frequency band covering a 850 MHz band and a resonance frequency band covering a 900 MHz band. In this way, the computer 100 is applicable to various destinations.

Moreover, the computer 100 may be provided with two wireless communication modules corresponding to two, that is, first and second wireless communication systems. In this case, two frequency bands corresponding to these two wireless communication systems may be covered using a reconfigurable antenna. In this case, the following switching is carried out in accordance with the kind of wireless communication systems used by users. Namely, a resonance frequency band of the antenna 210 is switched between a first resonance frequency band covering a frequency band used according to the first wireless communication system and a second resonance frequency band covering a frequency band used according to the second wireless communication system.

Hereinafter, the case where the computer 100 is used in a region in which an 850 MHz band is used will be described.

A feeder line 50 comprises one cable such as a coaxial cable. This cable penetrates the inside of the hinge member 120. The cable is guided from the computer main body 300 to the display unit 200 by way of the hinge member 120.

The computer 100 of this embodiment has a function of changing the orientation of a screen image displayed on a display screen of the LCD 201 of the display unit 200. This screen image orientation change function enables user's availability of the following four orientations of the display unit 200 in a “tablet style”.

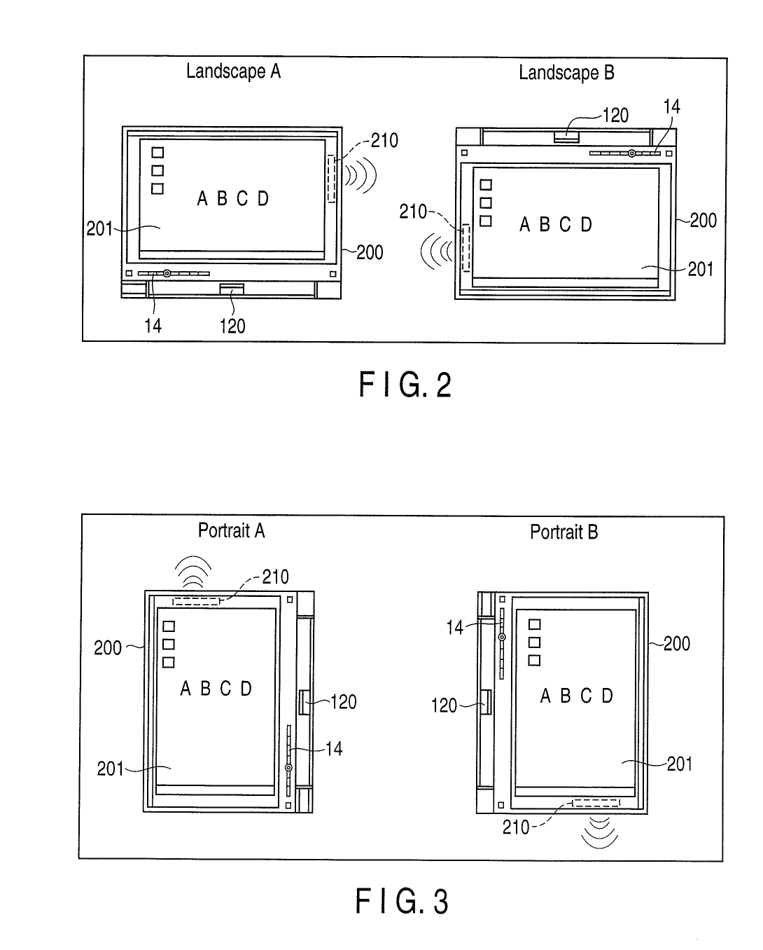

FIG. 2 and FIG. 3 are views to explain the kind of display modes usable in a “tablet style”. As can be seen from FIG. 2 and FIG. 3, in a “tablet style”, four display modes are usable depending on the orientation of a screen image displayed on the LCD 201. The foregoing display mode is largely divided into a “landscape” mode (long sideways display) and a “portrait” mode (long vertical display).

As shown in FIG. 2, the foregoing “landscape” mode has two modes, that is, a landscape mode A and a landscape mode B. According to the landscape mode A, the orientation of a screen image is set so that the upper side of the screen image is positioned on the upper side of the display unit 200 while the lower side thereof is positioned on the lower side thereof. According to the landscape mode B, the orientation of a screen image is rotated by an angle of 180° to the orientation of the screen image according to the landscape mode A. Specifically, according to the landscape mode B, the orientation of a screen image is set so that the upper side of the screen image is positioned on the lower side of the display unit 200 while the lower side thereof is positioned on the upper side thereof.

As illustrated in FIG. 3, the foregoing “portrait” mode has two modes, that is, a portrait mode A and a portrait mode B. According to the portrait mode A, the orientation of a screen image is set so that the upper side of the screen image is positioned on the right end side of the display unit 200 while the lower side thereof is positioned on the left end side thereof. According to the portrait mode B, the orientation of a screen image is rotated by an angle of 180° to the orientation of the screen image according to the portrait mode A. Specifically, according to the portrait mode B, the orientation of a screen image is set so that the upper side of the screen image is positioned on the left end side of the display unit 200 while the lower side thereof is positioned on the right end side thereof.

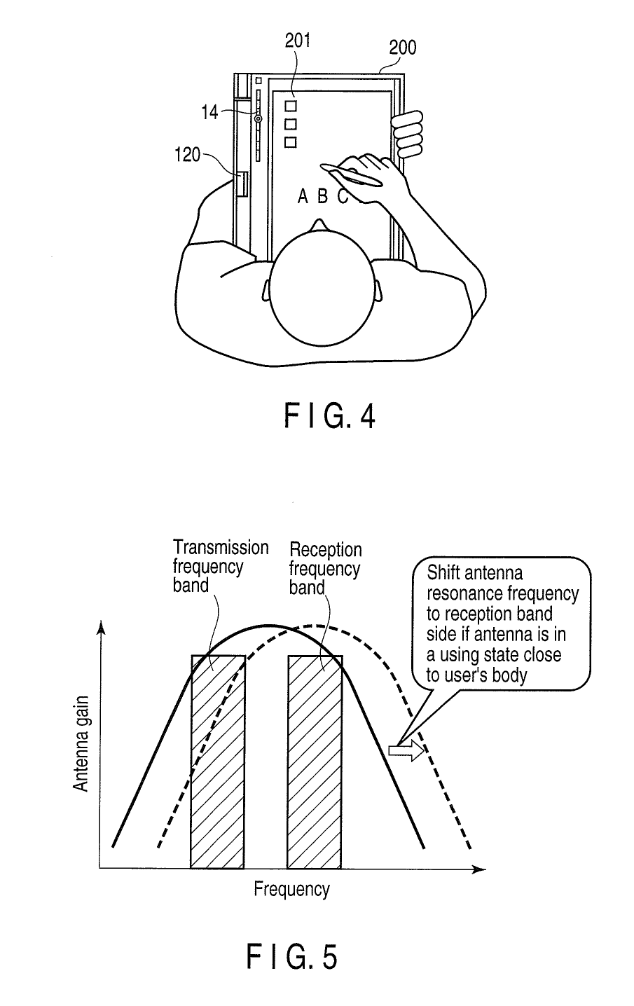

When the portrait mode B is used, as seen from FIG. 4, there is a possibility that a user operates a computer 100 in a state that the right end side of the display unit 200 closely contacts the user's abdominal region. According to this embodiment, the antenna 210 is arranged on the right end side of the display unit 200. Therefore, the user's state shown in FIG. 4 is an available mode in which an electric wave radiation from the antenna 210 gives a big influence to the user. A transmission power used for a mobile wireless communication system such as 3G is relatively high; for this reason, there is a need to restrict the electric wave radiation in the user's state shown in FIG. 4.

The user's state shown in FIG. 4 occurs when the following condition is established. According to this condition, the computer 100 is used in the “tablet style” and the orientation of a screen image is set in an orientation in which the antenna 210 is positioned on the downward side (lower side) of the screen image.

In order to reduce an influence of an electric-wave radiation from the antenna 210, that is, an electromagnetic radiation given to a user, the computer 100 of this embodiment has the following function. Namely, the computer 100 has a function of automatically shifting a resonance frequency of the antenna 210 to a higher band side (i.e., reception band side). The resonance frequency shift function is realized by shifting a resonance frequency band of the antenna 210 from the foregoing first resonance frequency band to the foregoing second resonance frequency band. The second resonance frequency band covers a frequency range higher than the first resonance frequency band, and is overlapped with a part of the first resonance frequency band.

FIG. 5 is a graph to explain a frequency characteristic of the antenna 210. Usually, a resonance frequency band of the antenna 210 is set to a first resonance frequency band. In this case, as shown by the solid-line curve in FIG. 5, the antenna 210 covers both of transmission and reception frequency bands used by the wireless communication module 310, which performs a wireless communication according to frequency division multiplexing. The gain of the antenna 210 between transmission and reception frequency bands is approximately the same level.

The computer 100 of this embodiment shifts a resonance frequency of the antenna 210 to a higher band side (i.e., reception frequency band side) as shown by the dotted line in FIG. 5 when the following condition is established. Namely, the computer 100 is used in the “tablet style” and the orientation of a screen image is set in a manner in which the antenna 210 is positioned on the lower side of the screen image. More specifically, the computer 100 shifts a resonance frequency band of the antenna 210 from a first resonance frequency band to a second resonance frequency band corresponding to the characteristic curve shown by the dotted line in FIG. 5. In this way, it is possible to reduce the gain of the antenna 210 in a transmission frequency band, and to reduce an electric-wave radiation from the antenna 210 without specially controlling a transmission power of the wireless communication module 310.

The second resonance frequency band is overlapped with a part of the first resonance frequency band, and covers a frequency range higher than the first resonance frequency band. The transmission frequency band exists in a frequency range lower than the reception frequency band. Therefore, the resonance frequency band of the antenna 210 is stepped up from a first resonance frequency band to a second resonance frequency band. In this way, it is possible to reduce the gain of the antenna 210 in a transmission frequency band.

As described above, the transmission frequency band is lower than the reception frequency band. Therefore, if a method of shifting a resonance frequency band of the antenna 210 to the reducing direction is employed, a shift of a resonance frequency required for reducing the antenna gain of the transmission frequency band becomes very large.

According to this embodiment, the resonance frequency band of the antenna 210 is shifted to the stepped-up direction. Therefore, a frequency band overlapped with a part of the first frequency band is usable as a second frequency band. In other words, a slight resonance frequency shift enables effective restriction of an electric-wave radiation from the antenna 210.

As a general antenna frequency characteristic, the antenna gain becomes highest at the center area of a resonance frequency band. Conversely, the antenna gain becomes low in the end area on a low frequency side of a resonance frequency band and in the end area on a high frequency side of the resonance frequency band. As can be seen from FIG. 5, according to this embodiment, the resonance frequency of the antenna 210 is shifted to a higher band side so that at least part of the end area on a low frequency side of a second resonance frequency band is overlapped with a transmission frequency band. As described above, the end area on a low frequency side having low antenna gain is overlapped with a transmission frequency band, and in this way, the electric-wave radiation from the antenna 210 is reduced.

Usually, a frequency range capable of obtaining antenna gain capable of performing wireless communication, in other words, for example, a frequency range capable of obtaining −5 db or more antenna efficiency is available as its antenna resonance frequency band. However, according to this embodiment, the antenna gain of the end area on a low frequency side of a second resonance frequency band may be lower by about 10 db than the normal antenna efficiency (e.g., −5 db or more antenna efficiency) capable of performing wireless communication. Therefore, according to this embodiment, for example, a frequency range capable of obtaining an antenna efficiency of −15 db or more is available as an antenna resonance frequency band.

The resonance frequency is shifted, and thereafter, the antenna 210 has a characteristic shown by the dotted line such that the antenna gain of a reception frequency band is higher than that of a transmission frequency band. As a result, it is possible to reduce electric-wave radiation from the antenna 210 without controlling a transmission power of the wireless communication module 310. After the resonance frequency is shifted, the gain of the antenna 210 of a transmission frequency band is kept higher than zero “0”. Moreover, the gain of the antenna 210 of a reception frequency band is kept at the same preferable value as that before resonance frequency shift. Therefore, even if a resonance frequency is shifted, the computer 100 is capable of normally performing wireless communication in many regions except regions where the electric-wave environment is extremely bad.

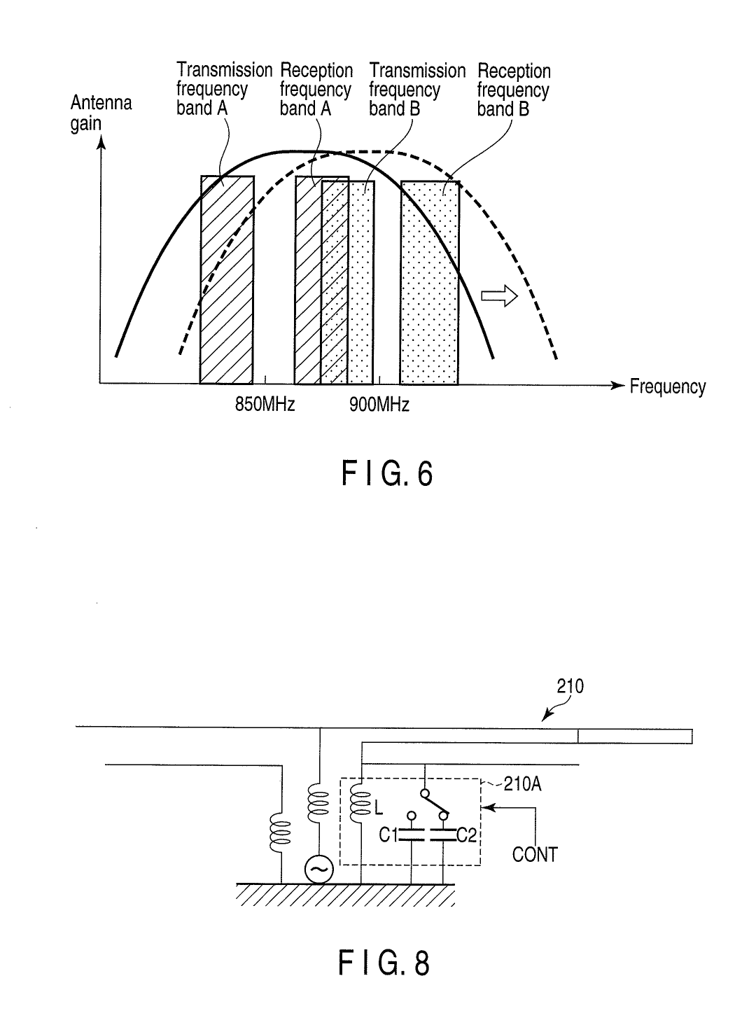

FIG. 6 is a graph to explain a detailed example of a frequency characteristic of the antenna 210. In this case, the antenna 210 is realized as a reconfigurable antenna, which is capable of changing the resonance frequency between a first resonance frequency covering the foregoing 850 MHz band and a second resonance frequency covering the foregoing 900 MHz. The resonance frequency band of the antenna 210 is switched between the first resonance frequency band (850 MHz band) and the second resonance frequency band (900 MHz band) using a switch circuit (i.e., resonance frequency shift circuit) attached to the antenna 210.

In the 850 MHz band, a transmission frequency band A (824 MHz to 849 MHz) and a reception frequency band A (869 MHz to 894 MHz) are defined. In the 900 MHz band, a transmission frequency band B (880 MHz to 915 MHz) and a reception frequency band B (925 MHz to 960 MHz) are defined.

Usually, the resonance frequency of the antenna 210 is set to a first resonance frequency. Thus, a frequency band (resonance frequency band) covered by the antenna 210 is set to a first frequency band shown by the solid line in FIG. 6. The foregoing first frequency band covers at least transmission frequency band A (824 MHz to 849 MHz) and a reception frequency band A (869 MHz to 894 MHz). The resonance frequency of the antenna 210 is switched from a first resonance frequency band to a second resonance frequency band by the foregoing switch circuit. In this case, a frequency band (resonance frequency band) covered by the antenna 210 is changed to a second frequency band shown by the dotted line in FIG. 6. The second frequency band covers at least transmission frequency band B (880 MHz to 915 MHz) and reception frequency band B (925 MHz to 960 MHz). Further, at least part of the end area of a low frequency side of the second frequency band is overlapped with the transmission frequency band A (824 MHz to 849 MHz). Thus, when the antenna 210 is set to the second frequency band, the gain of the antenna 210 of the transmission frequency band A is reduced. Therefore, it is possible to reduce an electric-wave radiation from the antenna 210 without controlling a transmission power of the wireless communication module 310, which wirelessly transmits signals belonging to the transmission frequency band A.

The system configuration of the computer 100 will be explained below with reference to FIG. 7.

A main body 300 of the computer 100 includes a CPU 111, a north bridge 112, a main memory 113, a graphics controller 114 and a south bridge 115. Further, the main body 300 includes a BIOS-ROM 120, a hard disk drive (HDD) 130, an optical disk drive (ODD) 140, an embedded controller/keyboard controller IC (EC/KBC) 160 and a power circuit 170.

Specifically, the CPU 111 is a processor for controlling the operation of the computer 100. This CPU executes an operating system, a utility program 113A and various application programs, which are loaded from the HDD 130 to the main memory 113. The utility program 113A is a program for controlling the orientation of a screen image and a resonance frequency of the antenna 210. Moreover, the CPU 111 executes a system BIOS stored in the BIOS-ROM 120, that is, a BIOS (basic input output system). The system BIOS is a program for executing hardware control.

The north bridge 112 is a bridge device for making a connection between a local bus of the CPU 111 and the south bridge 115. The north bridge 112 has a built-in memory controller for controlling the access of the main memory 113. Further, the north bridge 112 has a function of performing a communication with the graphics controller 114.

The graphics controller 114 is a display controller for controlling an LCD 201. For example, the LCD 201 is realized as a touch screen device, which is capable of detecting a position touched by a pen or finger. Namely, the LCD 201 is provided with a transparent coordinate detection module 201A called as a tablet or touch panel. The south bridge 115 is connected to the EC/KBC 160 by way of an LPC (low pin count) bus.

The EC/KBC 160 is a microcomputer configured with an embedded controller for power management and a keyboard controller for controlling a keyboard (KB) 301 and a touch pad 302, which are integrated on a single chip. The EC/KBC 160 is associated with the power circuit 170, and thereby, has a power control function of turning on the power of the computer 100 in response to a user's operation of a power button on a control panel 14. The power circuit 170 generates a power to be supplied to various components included in the main body 300 using a power from a battery 171 or a power from an AC adaptor 172. Moreover, the foregoing EC/KBC 160 is connected to an acceleration sensor 15, a panel switch 16 and a revolution sensor 17.

The acceleration sensor 15 is built into the display unit 200 or main body 300, and detects the orientation of the computer 100 with respect to gravity. For example, when the computer 100 is used as a “tablet style” computer, the acceleration sensor 15 is used for detecting the orientation of the display unit (i.e., the orientation of the computer 100) with respect to the orientation of gravity. The panel switch 16 is a switch for detecting whether or not the display unit 200 is closed. The revolution sensor 17 detects whether the display unit 200 is set to either of the following first and second positions. One is a first position in which a display screen of the LCD 201 of the display unit 200 is oriented to the front side of the computer 100. The other is a second position in which the backside of the display unit 200 is oriented to the front side of the computer 100.

The antenna 210 is attached with a resonance frequency shift circuit 210A. This resonance frequency shift circuit 210A is the foregoing switch circuit for shifting a resonance frequency of the antenna 210. FIG. 8 is a circuit diagram showing each configuration of an antenna 210 and a resonance frequency shift circuit 210A.

As depicted in FIG. 8, the resonance frequency shift circuit 210A includes an inductor L and two capacitors C1 and C2. The resonance frequency shift circuit 210A switches a capacitor connected to the antenna 210 between capacitors C1 and C2 in accordance with a control signal CONT. The foregoing capacitors C1 and C2 have different capacitances from each other. A capacitor connected to the antenna 210, for example, a capacitor connected to a parasitic element added to the antenna 210 is switched from the capacitor C1 to the capacitor C2. In this way, the resonance frequency band of the antenna 210 is switched from the foregoing first resonance frequency band to the foregoing second resonance frequency band.

In general, if a wide-band antenna covering two frequency bands is realized, the size of the wide-band antenna becomes very large. According to this embodiment, the antenna 210 is configured to exclusively cover two frequency bands; therefore, this serves to make relatively small the size of the antenna 210.

Moreover, the following configuration may be employed. Namely, an antenna element covering a first resonance frequency band and an antenna element covering a second resonance frequency band are prepared as the antenna 210. A resonance frequency shift circuit 210A selects one of the foregoing two antenna elements.

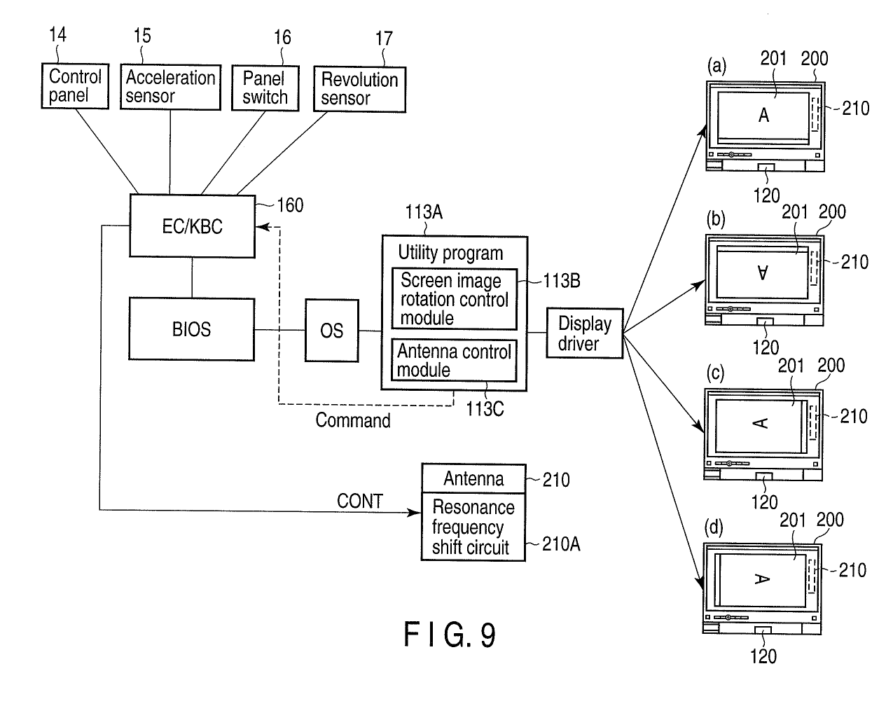

The function of a utility program 113A will be explained below with reference to FIG. 9.

A utility program 113A includes a screen image rotation control module 113B and an antenna control module 113C. The screen image rotation control module 113B functions as a screen image orientation control module, which changes the orientation of a screen image displayed on a display screen of the display unit 200. The modules 113B changes the orientation of a screen image displayed on a display screen of the display unit 200 in accordance with a predetermined button operation of the control panel 14 by the user or by the orientation of the computer 100 detected by the acceleration sensor 15. An event showing a predetermined button operation and information showing the orientation of the computer 100 with respect to gravity are supplied to the utility program 113A by way of EC/KBC 160, BIOS and OS. Moreover, the foregoing module 113B sets the orientation of a screen image displayed on the LCD 201 to any one of four orientations shown by (a), (b), (c) and (d) of FIG. 9 using a display driver. When the orientation of a screen image is changed in accordance with the orientation of the computer 100 detected by the acceleration sensor 15, the orientation of a screen image is switched between the foregoing four orientations so that the orientation of a screen image is aligned with the orientation of gravity.

The antenna control module 113C controls the resonance frequency shift circuit (switch circuit) 210A, and thereby, functions as a resonance frequency shift module for shifting a resonance frequency band of the antenna 210. Moreover, the module 113C determines whether or not the following condition is established. According to the condition, the computer 100 is used in a “tablet style” and the orientation of a screen image is set in a state that the antenna 210 is positioned on the downward side of the screen image. If it is determined that the foregoing condition is established, the antenna control module 113C transmits a command of shifting a resonance frequency of the antenna 210 to the EC/KBC 160 in order to control the resonance frequency shift circuit (switch circuit) 210A. In response to the received command, the EC/KBC 160 supplies the foregoing control signal CONT to the resonance frequency shift circuit 210A.

When the computer 100 is used in a “pc style” as well as “tablet style”, the orientation of a screen image displayed on the LCD 201 may be changed in accordance with the user's button operation or the orientation of the computer 100 with respect to gravity.

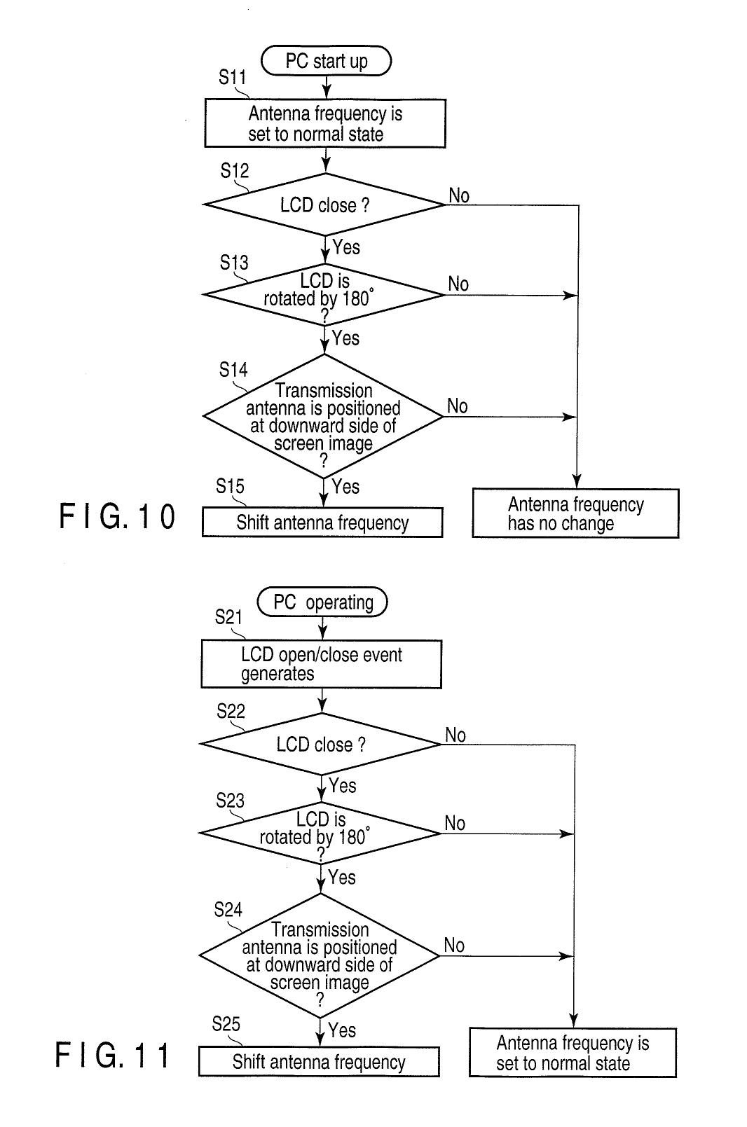

The procedures executed by the utility program 113A when the computer 100 starts up will be explained below with reference to a flowchart of FIG. 10. When the computer 100 is started up, the resonance frequency of the antenna 210 is set to the foregoing first resonance frequency (step S11). The utility program 113A acquires open/close information showing that the display panel 200 is in an open or closed state by way of the BIOS. Further, the program 113A acquires rotation angle information showing that the rotation angle of the display panel 200 is positioned at an angle of 0° or 180° by way of the BIOS.

Then, the utility program 113A determines whether or not the computer 100 is set to a “tablet style”, that is, the backside of the display unit 200 is set to a position covering the upper surface of the computer 100 based on the foregoing open/close information and rotation angle information. More specifically, first, the program 113A determines whether or not the display unit 200 is closed based on the open/close information (step S12). If the display unit 200 is closed (YES in step S12), the utility program 113A determines whether or not the rotation angle (LCD rotation angle) of the display panel 200 is 180° based on the rotation angle information (step S13).

If the LCD rotation angle is 180° (YES in step S13), the utility program 113A determines whether or not the orientation of the current screen image displayed on the LCD 201 is set to a predetermined orientation such that the antenna 210 is positioned on the downward side of a screen image (step S14). If the orientation of the current screen image is set to a predetermined orientation, that is, the downward side of the screen image is oriented to the right end side on the display unit 200 (YES in step S14), the utility program 113A executes the following procedures. Namely, the program 113A controls the resonance frequency shift circuit (switch circuit 210A) so that a resonance frequency band of the antenna 210 is shifted from the foregoing first resonance frequency band to the foregoing second resonance frequency band (step S15).

The procedures executed by the utility program 113A in the case where an LCD open/close event generates when the computer 100 is operating will be explained below with reference to a flowchart of FIG. 11.

After the computer 100 starts up, that is, when the computer 100 is operating, a user opens or closes the display panel 200. In this case, in response to a detection signal from the panel switch 16, the BIOS gives information on an LCD open/close event showing that the display panel 200 is opened or closed to the utility program 113 by way of the OS. When receiving an LCD open/close event from the BIOS (step S21), the utility program 113A acquires open/close information and rotation angle information from the BIOS.

First, based on the foregoing open/close information, the utility program 113A determines whether or not the display unit 200 is closed (step S22). If the display unit 200 is closed (YES in step S22), the utility program 113A determines whether or not the rotation angle (LCD rotation angle) of the display panel 200 is 180° based on the foregoing rotation angle information (step S23).

If the LCD rotation angle is 180° (YES in step S23), the utility program 113A determines whether or not the orientation of the current screen image displayed on the LCD 201 is set to a predetermined orientation such that the antenna 210 is positioned on the downward side of a screen image (step S24). If the orientation of the current screen image is set to a predetermined orientation (YES in step S24), the utility program 113A executes the following procedures. Namely, the program 113A controls the resonance frequency shift circuit (switch circuit 210A) so that a resonance frequency band of the antenna 210 is shifted from the foregoing first resonance frequency band to the foregoing second resonance frequency band (step S25).

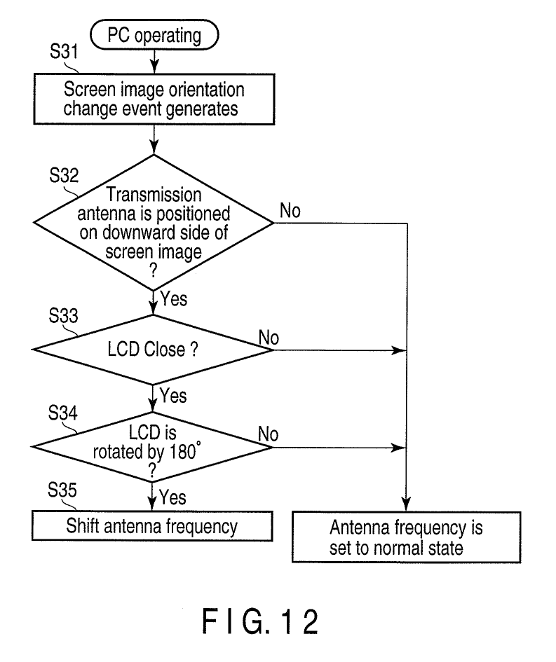

The procedures executed by the utility program 113A in the case where the orientation of a screen image is changed when the computer 100 is operating will be explained below with reference to a flowchart of FIG. 12.

The utility program 113A changes the orientation of a screen image in accordance with a button operation by user or a change of the orientation of the computer 100 detected by the acceleration sensor 15 (step S31). In this case, first, the utility program 113A determines whether or not the orientation of the changed screen image is set to a predetermined orientation such that the antenna 210 is positioned on the downward side of a screen image (step S32). If the orientation of the current screen image is set to a predetermined orientation, that is, the downward side of the screen image is oriented to the right end side on the display unit 200 (YES in step S32), the utility program 113A executes the following procedure. Namely the utility program 113A acquires open/close information and rotation angle information from the BIOS.

Then, based on the foregoing open/close information, the utility program 113A determines whether or not the display unit 200 is closed (step S3). If the display unit 200 is closed (YES in step S33), the utility program 113A determines whether or not the rotation angle (LCD rotation angle) of the display panel 200 is 180° based on the foregoing rotation angle information (step S24).

If the LCD rotation angle is 180° (YES in step S34), the utility program 113A executes the following procedures. Namely, the program 113A controls the resonance frequency shift circuit (switch circuit 210A) so that a resonance frequency band of the antenna 210 is shifted from the foregoing first resonance frequency band to the foregoing second resonance frequency band (step S35).

In FIG. 10 to FIG. 12, the operation of shifting a resonance frequency band from the first resonance frequency band to the second resonance frequency band has been mainly explained. The available mode of the computer 100 is changed from the available mode in which the antenna 210 is positioned on the downward side of a screen image to another available mode. In this case, the program 113A controls the resonance frequency shift circuit (switch circuit 210A) so that a resonance frequency band of the antenna 210 is shifted from the foregoing second resonance frequency band to the foregoing first resonance frequency band.

As described above, according to this embodiment, a frequency band covered by the antenna 210 is automatically changed in accordance with the available mode of the computer 100. Therefore, it is possible to reduce the influence of electric-wave radiation to the human body without restricting a transmission power of the wireless communication module 310 or stopping the output of a transmission signal of the module 310.

Moreover, this embodiment has given attention to the fact that a transmission frequency band is lower than a reception frequency band. Based the foregoing fact, a resonance frequency band of the antenna 210 is shifted to an increase direction. In this way, a frequency band overlapped with a part of a first frequency band is used as a second frequency band. In other words, it is possible to effectively restrict electric-wave radiation from the antenna 210 using a slight amount of resonance frequency shift.

In addition, a second resonance frequency band is set so that at least part of the end area on the low-frequency side of the second resonance frequency band is overlapped with a transmission frequency band. Therefore, the resonance frequency band is shifted, and thereafter, wireless communications is continuously performed.

This embodiment relates to the case where the computer 100 is a “compatible tablet personal computer (PC)”. In this case, the configuration of this embodiment is applicable to a so-called “pure-tablet personal computer (PC)”, which is configured so that system components of a main body 300 of the “compatible tablet PC” are included in a box body of a display unit. In this case, the shift of a resonance frequency may be carried out when the orientation of the current screen image displayed on the LCD 201 is set to a predetermined orientation such that the antenna 210 is positioned on the downward side of the screen image.

Further, this embodiment relates to the case where the antenna 210 is arranged on the right end of the display unit 200. For example, the antenna 210 may be arranged on the left end of the display unit 200 or the upper end thereof.

Moreover, the function of the utility program of this embodiment is realizable by means of a hardware module.

The various modules of the systems described herein can be implemented as software applications, hardware and/or software modules, or components on one or more computers, such as servers. While the various modules are illustrated in particular, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. An information processing apparatus comprising a display comprising an antenna, the apparatus comprising:
a switch module configured to switch a resonance frequency band of the antenna between first and second resonance frequency bands, the first resonance frequency band covering a first transmission frequency band and a first reception frequency band higher than the first transmission frequency band, the second resonance frequency band being overlapped with a portion of the first resonance frequency band and being higher than the first resonance frequency band;
a wireless communication module configured to wirelessly transmit and receive signals using the first transmission frequency band and the first reception frequency band;
a screen image orientation control module configured to change an orientation of a screen image displayed on a display screen of the display; and
a resonance frequency shift module configured to shift the resonance frequency band of the antenna from the first resonance frequency band to the second frequency band by controlling the switch module when the orientation of the screen image is an orientation in which the antenna is positioned on a downward side of the screen image.

2. The apparatus of claim 1, wherein at least a portion of an end area on a low-frequency side of the second resonance frequency band is overlapped with the first transmission frequency band.

3. The apparatus of claim 1,
wherein the second resonance frequency band comprises a second transmission frequency band and a second reception frequency band, and
wherein the wireless communication module is further configured to wirelessly transmit signals via the second transmission frequency band and to wirelessly receive signals via the second reception frequency band.

4. The apparatus of claim 1, further comprising an acceleration sensor configured to detect an orientation of the information processing apparatus with respect to gravity, and
wherein the screen image orientation control module is configured to change the orientation of the screen image according to the detected orientation of the information processing apparatus with respect to gravity, and
the resonance frequency shift module is configured to shift a resonance frequency band of the antenna from the first resonance frequency band to the second resonance frequency band when the changed orientation of the screen image is set to an orientation in which the antenna is positioned on the downward side of the screen image.

5. An information processing apparatus comprising:
a main body;
a display attached to the main body, and comprising an antenna;
a switch module configured to switch a resonance frequency band of the antenna between first and second resonance frequency bands, the first resonance frequency band covering a first transmission frequency band and a first reception frequency band higher than the first transmission frequency band, the second resonance frequency band being overlapped with a portion of the first resonance frequency band and being higher than the first resonance frequency band;
a wireless communication module configured to wirelessly transmit and receive signals using the first transmission frequency band and the first reception frequency band;
a screen image orientation control module configured to change an orientation of a screen image displayed on a display screen of the display; and
a resonance frequency shift module configured to determine whether a condition that the display is set to a position in which a backside of the display covers the upper surface of the main body and the orientation of the screen image displayed on the display screen is set to an orientation in which the antenna is positioned on the downward side of the screen image is satisfied, and to shift the resonance frequency band of the antenna from the first resonance frequency band to the second frequency band by controlling the switch module if the condition is satisfied.

6. The apparatus of claim 5, wherein at least a portion of an end area on a low-frequency side of the second resonance frequency band is overlapped with the first transmission frequency band.

7. The apparatus of claim 5,
wherein the second resonance frequency band comprises a second transmission frequency band and a second reception frequency band, and
wherein the wireless communication module is further configured to wirelessly transmit signals via the second transmission frequency band and to wirelessly receive signals via the second reception frequency band.

8. A control method of controlling an operation of an information processing apparatus configured to wirelessly transmit signals using a first transmission frequency band and to wirelessly receive signals using a first reception frequency band higher than the first transmission frequency band, the apparatus comprising a display comprising an antenna, the method comprising:
changing an orientation of a screen image displayed on a display screen of the display; and
shifting a resonance frequency band of the antenna from a first resonance frequency band covering the first transmission frequency band and the first reception frequency band to a second resonance frequency band overlapped with a portion of the first resonance frequency band and higher than the first resonance frequency band when the orientation of the screen image is an orientation in which the antenna is positioned on a downward side of the screen image.

9. The method of claim 8, wherein at least a portion of an end area on a low-frequency side of the second resonance frequency band is overlapped with the first transmission frequency band.

10. The method of claim 8,
wherein the second resonance frequency band comprises a second transmission frequency band and a second reception frequency band, and
wherein the information processing apparatus is further configured to wirelessly transmit signals via the second transmission frequency band and to wirelessly receive signals via the second reception frequency band.
